(19) United States
(12) Patent Application Publication
(10) Pub. No.: US 2010/0241852 A1
(43) Pub. Date: Sep. 23, 2010

(54) Methods for Producing Products with Certificates and Keys

(76) Inventors: Rotem Sela, Maalot (IL); Vijay Ahuja, Raleigh, NC (US); Michael Holtzman, Cupertino, CA (US); John Michael Podobnik, Fremont, CA (US); Avi Shmuel, Kfar-Sirkin (IL)

Correspondence Address: BRINKS HOFER GILSON & LIONE/SanDisk, P.O. BOX 10395, CHICAGO, IL, 60610, US

(21) Appl. No.: 12/408,308

(22) Filed: Mar. 20, 2009

(51) Int. Cl. H04L 9/32; H04L 9/08; H04L 9/14

(52) U.S. Cl. 713/156; 380/281

(57) ABSTRACT

The embodiments described herein provide methods for producing products with certificates and keys. In one embodiment, a requesting entity transmits a request for a plurality of certificates and corresponding keys to a certifying entity that generates the certificates and corresponding keys. The request preferably includes information for use by the certifying entity to verify an identity of the requesting entity rather than information to verify unique product identifiers of the respective products. The requesting entity then receives the plurality of certificates and corresponding keys from the certifying entity, preferably in a plurality of organized sets instead of in a single series of certificates. The requesting entity then stores the certificates and corresponding keys in respective products. Each stored certificate is thereafter useable for both identification and authentication of the respective product in which it is stored.

### BACKGROUND

Products that are part of the Public Key Infrastructure (PKI) store a certificate to authenticate the product, as well as corresponding public and private keys. In one approach to storing a certificate and corresponding keys in a product, the product generates a key pair of public and private keys and a certificate request, which includes identification data of the product and the generated public key. The product then signs the certificate request with the generated private key and sends the signed certificate request to a Product Proxy (e.g., a host computer), which contacts a Registration Authority. The Registration Authority verifies the product's identification data and key pair and then contacts a Certificate Authority to issue a certificate. The Certificate Authority generates a certificate, signs the certificate with its own private key, and then sends the certificate back to the Registration Authority, which returns the certificate to the product via the Product Proxy. While this process works well when certificates are to be issued to an individual hardware product (e.g., a single server), this process may be too long and inefficient when certificates are to be stored in a large number of products in a manufacturing process because of the relatively-long time needed for each product to generate its own key pair, as well as the relatively-long time needed to communicate among four parties (the product, the Product Proxy, the Registration Authority, and the Certificate Authority).

VeriSign® Device Certificate Service provides a high-volume batch process to issue certificates that are to be embedded into products in a manufacturing process. In operation, a product manufacturer provides VeriSign® with a list of unique product identifiers for its products (e.g., media access control (MAC) addresses of cable modems) through a Web interface. VeriSign® issues the certificates and corresponding public and private key pairs and securely sends them in an encrypted form to the manufacturer via the Internet. The manufacturer decrypts the certificates and corresponding keys and embeds them in products during the manufacturing process.

### SUMMARY

The concept(s) presented herein can be implemented in various embodiments, and this summary includes a number of exemplary embodiments.

By way of introduction, the embodiments described below provide methods for producing products with certificates and keys. In one embodiment, a requesting entity transmits a request for a plurality of certificates and corresponding keys to a certifying entity that generates the certificates and corresponding keys. The request preferably includes information for use by the certifying entity to verify an identity of the requesting entity rather than information to verify unique product identifiers of the respective products. The requesting entity then receives the plurality of certificates and corresponding keys from the certifying entity, preferably in a plurality of organized sets instead of in a single series of certificates. The requesting entity then stores the certificates and corresponding keys in respective products. Each stored certificate is thereafter useable for both identification and authentication of the respective product in which it is stored.

Each of the embodiments described herein can be used alone or in combination with one another. Various embodiments will now be described with reference to the attached drawings.

### BRIEF DESCRIPTION OF THE DRAWINGS

FIG. 1 is an illustration of a system of an embodiment for producing products with certificates and keys.

FIG. 2 is a flow chart of a method of an embodiment for producing products with certificates and keys.

FIG. 3 is an illustration of an exemplary request form of an embodiment.

FIG. 4 is an illustration of an exemplary format of an embodiment used to transmit certificates and corresponding keys.

### DETAILED DESCRIPTION OF THE PRESENTLY PREFERRED EMBODIMENTS

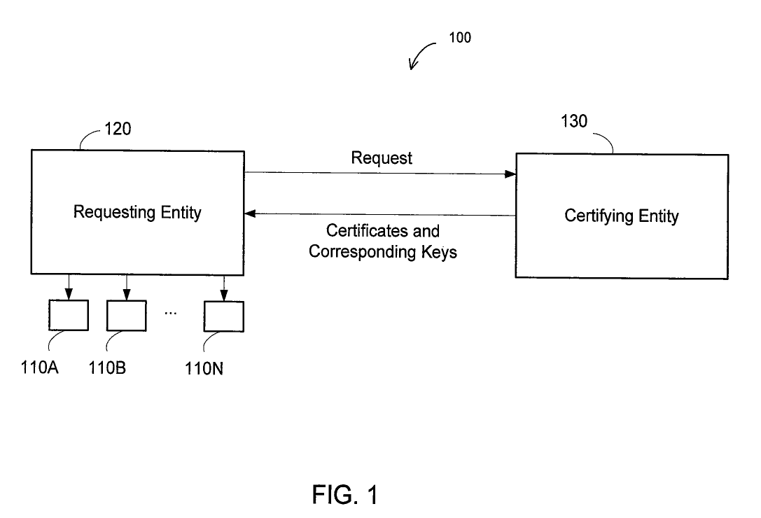

Turning now to the drawings, FIG. 1 is an illustration of a system 100 of an embodiment for producing products 110A, 110B, . . . 110N with certificates and keys. In general, a requesting entity 120 transmits a request for certificates and corresponding keys to a certifying entity 130, the certifying entity 130 generates and provides the requesting entity 120 with the requested certificates and corresponding keys, and the requesting entity 120 stores the certificates and corresponding keys in respective products 110A, 110B, . . . 110N, thereby transforming the products 110A, 110B, . . . 110N from products that did not store certificates and corresponding keys to products that store certificates and corresponding keys. Once stored in a product, the certificate and corresponding key can not only be used to authenticate the product (e.g., to a content server that provides content to the product), but also to identify the product.

As used herein, a “requesting entity” refers to an entity that requests certificates and corresponding keys and is typically a product manufacturer (e.g., a memory card manufacturer). As also used herein, a “certifying entity” refers to an entity that verifies an identity of a requesting entity and generates requested certificates and corresponding keys. As will be clear from the below discussion, the requesting entity 120 and the certifying entity 130 can communicate with each other in any suitable form, either directly or indirectly. “Products” can also take any suitable form and generally contain a memory unit and an interface used to communication with another device. Examples of “products” include, but are not limited to, removable mass storage devices (such as non-volatile, solid-state (e.g., flash) memory cards), solid-state drives (SSDs), smart cards, optical or magnetic memory devices, game consoles, digital video recorders, set-top boxes, mobile phones, ATM machines, cable modems, personal digital assistants (PDAs), email/text messaging devices, digital media players, personal computers, and GPS navigation devices.

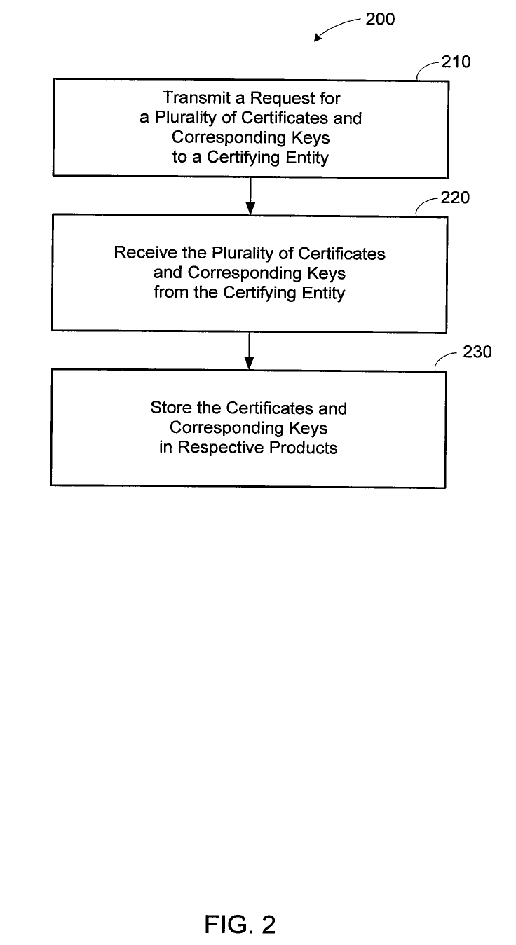

Returning to the drawings, FIG. 2 is a flow chart 200 of a method of an embodiment for producing products with certificates and keys using the system 100 of FIG. 1. First, the requesting entity 120 transmits a request for a plurality of certificates and corresponding keys to the certifying entity 130, which generates the certificates and corresponding keys (act 210). The request can be transmitted in any suitable form. For example, the request can be electronically sent to the certifying entity 130 via a communication channel (e.g., the Internet), can be stored on a portable storage device (e.g., a DVD) which is then mailed to the certifying entity 130, can be in paper form and mailed or faxed to the certifying entity 130, or can be orally communicated (e.g., via a telephone) to the certifying entity 130. For security reasons, it is preferred that the requesting entity 120 sign the request with a private key previously-received from the certifying entity 130. For added security, the request can be encrypted prior to transmission to the certifying entity 130, as will be discussed in more detail below.

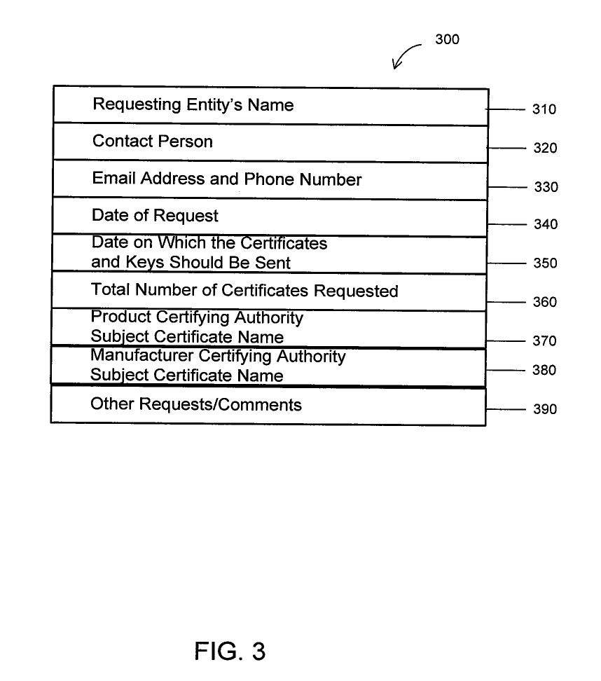

The request itself can contain any desired information. FIG. 3 is an illustration of an exemplary request form 300 of an embodiment. As shown in FIG. 3, the fields in this form 300 include the requesting entity's name (310), the contact person (320) and email address and phone number (330) of the requesting entity, the date of the request (340), the date on which the certificates and keys should be sent (350), the total number of certificates requested (360), the product certifying authority subject certificate name (370), the manufacturer certifying authority subject certificate name (380), and other requests/comments (390). In one embodiment, the form 300 is placed in a PDF file and signed with a private key. Also, the request preferably includes information for use by the certifying entity 130 to verify the identity of the requesting entity 120 (e.g., a signature of the request by a private key previously provided to the requesting entity 120 by the certifying entity 130) rather than information to verify unique product identifiers (e.g., media access control (MAC) addresses) of the respective products.

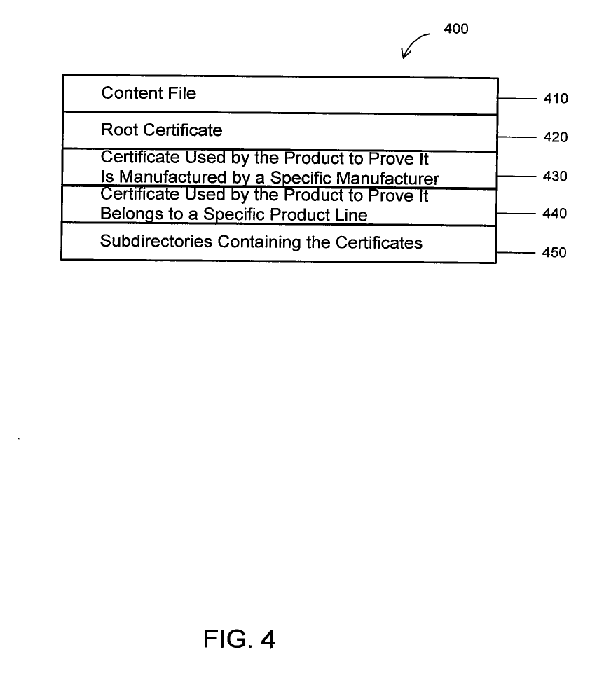

Referring back to FIG. 2, the requesting entity 120 receives the plurality of certificates and corresponding keys from the certifying entity 130 (act 220). As with the request transmission act described above, the plurality of certificates and corresponding keys can be received by the requesting entity 120 in any suitable manner. For example, the certificates and keys can be electronically sent to the requesting entity 120 via a communication channel (e.g., as a compressed file over the Internet) or can be stored on a portable storage device (e.g., a DVD) and mailed to the requesting entity 120. FIG. 4 is an illustration of an exemplary format 400 used to transmit certificates from the certifying entity 130 to the requesting entity 120. As shown in FIG. 4, the fields in this format 400 include a content information file (410) (e.g., version number, unique identifier, creation date and time, number of certificates, and comments), a root certificate (420), a certificate used by the product to prove it is manufactured by a specific manufacturer (430), a certificate used by the product to proof it belongs to a specific product line (440), and subdirectories containing the certificates (450). For security reasons, the certifying entity 130 can sign the transmission with its private key. For additional security, the transmission can be encrypted, as will be described below. While the plurality of certificates and corresponding keys can be received from the certifying entity 130 individually or in multiple batches, in one embodiment, the plurality of certificates and corresponding keys are received from the certifying entity 130 in a single batch, which can be, for example, burned and delivered on a DVD or delivered using any of the other forms noted above. Once received, the requesting entity 120 retrieves the plurality of certificates and corresponding keys from the batch.

The requesting entity 120 then verifies the incoming package of certificates and keys using the certifying entity's certificate and stores individual certificates and corresponding keys in respective products 110A, 110B, . . . 110N (act 230). Each certificate is then useable for both identification and authentication of the respective product 110A, 110B, . . . 110N in which it is stored. To securely store the certificates and keys in the products 110A, 110B, . . . 110N, the certificates and keys can be encrypted, preferably using a different key from the one used to encrypt the certificates and keys for transmission to the requesting entity 126, if such encryption was used. The requesting entity 120 can store individual certificates and corresponding keys in respective products 110A, 110B, . . . 110N using one or more computing devices (e.g., a general-purpose computer). Also, one or both of the transmitting and receiving acts (acts 210, 220) can use the same or different computing device(s), depending on whether a computing device is used in the transmitting and/or receiving acts. For example, the same or different computing device(s) that stores the certificates and keys can also be used to prepare the request (e.g., burn a DVD containing the request, email the request to the certifying entity 130 over the Internet, etc.) and/or receive the certificates and keys (e.g., by downloading the certificates and keys from the certifying entity 130 via a Web browser).

There are several advantages associated with these embodiments. First, because certificates are requested and received before the products 110A, 110B, . . . 110N are manufactured (i.e., the certificates are requested and received “off-line”), no time is wasted during the manufacturing process waiting for a certificate to arrive. Further, unlike the process described in the background section, in this embodiment, the products 110A, 110B, . . . 110N themselves do not generate public and private key pairs. Instead, the certifying entity 130 generates those pairs and sends them to the requesting entity 110 along with the corresponding certificates. In this way, no time is wasted during the manufacturing process waiting for the products 110A, 110B, . . . 110N to generate key pairs.

Further, because the requesting entity 120 in these embodiments is the manufacturer of the products and not the products 110A, 110B, . . . 110N themselves, the certifying authority 130 is operating on a per-manufacturer level and not on a per-product level. As a result, the certifying entity 130 need only verify the identity of the requesting entity 120 and not each individual product 110A, 110B, . . . 110N. Such verification can occur relatively easily and quickly (e.g., by verify that the request was signed by a private key previously provided to the requesting entity 120 by the certifying entity 130, by contacting a person at the requesting entity 120 who sent the certifying entity 130 a DVD order form, etc.) compared to verify unique product identifiers of each product (e.g., verifying media access control (MAC) addresses of cable modems). Because verification of the requesting entity 120 can be done directly and easily, these embodiments allow the process to bypass the Registration Authority, thereby saving time that otherwise would need to be spent communicating with the Registration Authority.

In should be noted that, in these embodiments, each certificate is useable for both identification and authentication of the respective product in which it is stored. The certificate can identify its respective product by a subject name of the certificate. While any suitable naming convention can be used for the subject name, in one embodiment, the naming convention uses one or more of the following fields: a time stamp indicating when the certificate was issued, a sequence number of issuance, and a name of the products being produced. For example, the naming convention can be: “<ProductName>MMDDYYYYXXXXXXXX”, where the <ProductName> is the name of the product line (not the name of an individual product), MM is the month the certificate was issued, DD is the day in the month the certificate was issued, YYYY is the year the certificate was issued, and XXXXXXXX is a sequential number of issuance. As can be seen from this exemplary identifier, a certificate is not bound to or identified by a unique identifier of an individual product. This is in contrast to the approach described in the background section, in which certificates are issued based on a list of unique product identifiers (e.g., media access control (MAC) addresses of cable modems). Further, these embodiments do not rely on a unique identifier of an individual product, which is especially beneficial when a product is initially anonymous and does not have a unique identifier (e.g., a removable memory card vs. a cable modem). Unlike cable modems which have uniqueness before storing a certificate, removable memory cards and other anonymous products gain uniqueness when a certificate is stored in them. As such, in addition to being used to authenticate, in these embodiments, a stored certificate is used to provide identification for a previously-anonymous product. So, unlike the approach described in the background section which uses a certificate to authenticate a product's identify, certificates in these embodiments are used to identify a product itself.

There are many alternatives that can be used with these embodiments. For example, for efficient certificate access, the plurality of certificates received from the certifying entity 130 can be presented as a plurality of organized sets instead of in a single series of certificates (e.g., in different ones of a plurality of directories or in a hierarchical directory tree instead of a single linear file or list). Organizing the plurality of certificates into sets makes access to a given certificate easier than if the certificates were contained in single list or file. As a simple example, bulk certificates can be stored in multiple directories, where each directory contains 1,024 certificates and is named with the certificates held in that directory (e.g., 1-1024, 1,025-2,048, etc.). To find a given certificate, a computing device at the requesting entity 120 would find the directory storing the certificate and then search through that directory for the certificate. Because there are relatively few certificates per directory, finding a certificate in a directory takes a relatively-short amount of time. In contrast, if all the certificates were stored in a single directory, the time to find a given certificate among thousands or millions of certificates would be substantially longer. Of course, this is merely one example, and other techniques can be used. For example, instead of placing the certificates in different directories, the certificates can be segmented or partitioned in other ways.

As another alternative, for added security, various encryption techniques can be used in this process. For example, to protect the request during transmission from the requesting entity 120 to the certifying entity 130, the request can be encrypted prior to transmission with a key (e.g., a “Request Encryption Key (REK)”) previously-received from the certifying entity 130. As another example, to protect certificates and keys during transmission from the certifying entity 130 to the requesting entity 120, the requesting entity 120 can send Product Encryption Key (PEKs) to the certifying entity 130 to encrypt each of the plurality of keys and corresponding certificates with a respective PEK. In this way, the plurality of keys and corresponding certificates would be received by the requesting entity 120 in encrypted form, and the requesting entity 120 would use the PEKs to decrypt each of the plurality of keys and corresponding certificates. Since such decryption would expose the plurality of certificates and keys, and the requesting entity can subsequently re-encrypt the plurality of certificates and keys using a different key. As yet another example, the requesting entity 120 can transmit an encryption key (e.g., a “Manufacturer Encryption Key (MEK)”) to the certifying entity 130, so that the certifying entity 120 can encrypt a batch of certificates and keys. After receiving the batch from the certifying entity 130, the receiving entity 120 would decrypt the batch with the MEK. Both PEK and MEK can be used to provide double encryption. Also, in one embodiment, prior to the requesting entity 120 requesting certificates and keys, the requesting entity 120 goes through a one-time set-up process with the certifying entity 130. During this process, the requesting entity 120 provides the certifying entity 130 with the REK and MEK. In this way, the REK and MEK exchange need only happen once and not every time the requesting entity 120 needs certificates and keys.

It is intended that the foregoing detailed description be understood as an illustration of selected forms that the embodiments can take and does not intend to limit the claims that follow. Also, some of the following claims may state that a component is operative to perform a certain function or configured for a certain task. It should be noted that these are not restrictive limitations. It should also be noted that the acts recited in the claims can be performed in any order -not necessarily in the order in which they are recited. Additionally, any aspect of any of the preferred embodiments described herein can be used alone or in combination with one another.

What is claimed is:

1. A method for producing products with certificates and keys, the method comprising:
transmitting, by a requesting entity, a request for a plurality of certificates and corresponding keys, the request being transmitted to a certifying entity that generates the certificates and corresponding keys;
receiving by the requesting entity the plurality of certificates and corresponding keys from the certifying entity; and
storing by the requesting entity the certificates and corresponding keys in respective products of the requesting entity;
wherein the request includes information for use by the certifying entity to verify an identity of the requesting entity rather than information to verify unique product identifiers of the respective products; and
wherein each certificate is useable for both identification and authentication of the respective product in which it is stored.

2. The method of claim 1 further comprising:
transmitting, by the requesting entity to the certifying entity, a product encryption key for use by the certifying entity to encrypt each of the plurality of keys and corresponding certificates;
wherein the plurality of keys and corresponding certificates received by the requesting entity are in encrypted form; and
wherein the storing further includes initially using the product encryption key to decrypt each of the plurality of keys and corresponding certificates received in encrypted form.

3. The method of claim 2, where the decrypting exposes the plurality of keys and certificates, and wherein the storing further includes subsequently re-encrypting the plurality of keys and corresponding certificates at the respective products of the requesting entity where they are being stored.

4. The method of claim 1, wherein each certificate is identified by one or more of the following: a time stamp indicating when the certificate was issued, a sequence number of issuance, and a name of the products being produced.

5. The method of claim 1, wherein the information to verify the identity of the requesting entity comprises a signature of the request by a private key previously provided to the requesting entity by the certifying entity.

6. The method of claim 1, wherein the unique product identifiers of the respective products comprise media access control addresses of the products.

7. The method of claim 1, wherein the request is transmitted to the certifying entity via a DVD or a communication channel.

8. The method of claim 7, wherein the communication channel comprises an internet connection.

9. The method of claim 1, wherein the plurality of certificates and corresponding keys are received from the certifying entity in a single batch, and wherein the method further comprises retrieving the plurality of certificates and corresponding keys from the batch.

10. The method of claim 9, wherein the batch is burned and delivered on a DVD.

11. The method of claim 9 further comprising:
transmitting an encryption key to the certifying entity, which encrypts the batch with the encryption key; and
after receiving the batch from the certifying entity, decrypting the batch with the encryption key.

12. The method of claim 1, wherein the products of the requesting entity comprise removable mass storage devices.

13. The method of claim 1 further comprising encrypting the request.

14. The method of claim 1, wherein the plurality of certificates are received from the certifying entity in a plurality of organized sets instead of in a single series of certificates.

15. The method of claim 14, wherein the plurality of certificates are received from the certifying entity in different ones of a plurality of directories.

16. The method of claim 14, wherein the plurality of certificates are organized in a hierarchical directory tree instead of a single linear file.

17. The method of claim 1, wherein the storing is performed by at least one computing device.

18. A method for producing products with certificates and keys, the method comprising:
transmitting, by a requesting entity, a request for a plurality of certificates and corresponding keys, the request being transmitted to a certifying entity that generates the certificates and corresponding keys;
receiving by the requesting entity the plurality of certificates and corresponding keys from the certifying entity; and
storing by the requesting entity the certificates and corresponding keys in respective products of the requesting entity;
wherein the plurality of certificates are received from the certifying entity in a plurality of organized sets instead of in a single series of certificates; and
wherein each certificate is useable for both identification and authentication of the respective product in which it is stored.

19. The method of claim 18 further comprising:
transmitting, by the requesting entity to the certifying entity, a product encryption key for use by the certifying entity to encrypt each of the plurality of keys and corresponding certificates;
wherein the plurality of keys and corresponding certificates received by the requesting entity are in encrypted form; and
wherein the storing further includes initially using the product encryption key to decrypt each of the plurality of keys and corresponding certificates received in encrypted form.

20. The method of claim 19, where the decrypting exposes the plurality of keys and certificates, and wherein the storing further includes subsequently re-encrypting the plurality of keys and corresponding certificates at the respective products of the requesting entity where they are being stored.

21. The method of claim 18, wherein each certificate is identified by one or more of the following: a time stamp indicating when the certificate was issued, a sequence number of issuance, and a name of the products being produced.

22. The method of claim 18, wherein the information to verify the identity of the requesting entity comprises a signature of the request by a private key previously provided to the requesting entity by the certifying entity.

23. The method of claim 18, wherein the request includes information for use by the certifying entity to verify an identity of the requesting entity rather than information to verify unique product identifiers of the respective products.

24. The method of claim 23, wherein the unique product identifiers of the respective products comprise media access control addresses of the products.

25. The method of claim 18, wherein the request is transmitted to the certifying entity via a DVD or a communication channel.

26. The method of claim 25 wherein the communication channel comprises an internet connection.

27. The method of claim 18, wherein the plurality of certificates and corresponding keys are received from the certifying entity in a single batch, and wherein the method further comprises retrieving the plurality of certificates and corresponding keys from the batch.

28. The method of claim 27, wherein the batch is burned and delivered on a DVD.

29. The method of claim 27 further comprising:
transmitting an encryption key to the certifying entity, which encrypts the batch with the encryption key; and
after receiving the batch from the certifying entity, decrypting the batch with the encryption key.

30. The method of claim 18, wherein the products of the requesting entity comprise removable mass storage devices.

31. The method of claim 18 further comprising encrypting the request.

32. The method of claim 18, wherein the plurality of certificates are received from the certifying entity in different ones of a plurality of directories.

33. The method of claim 18, wherein the plurality of certificates are organized in a hierarchical directory tree instead of a single linear file.

34. The method of claim 18, wherein the storing is performed by at least one computing device.
